(19) United States
(12) Patent Application Publication
(10) Pub. No.: US 2023/0141574 A1
(43) Pub. Date: May 11, 2023

(54) method for preparing a porous polymeric film material under high voltage and with high safety and a solid-state lithium battery using the porous polymeric film material

(71) Applicant: CHIN-SHI Electronic Materials Co., Ltd., Hsin-Chu Hsien (TW)

(72) Inventors: HUI-TUNG KUO, Hsin-Chu Hsien (TW); GILANG BASWARA ANGGARA PUTRA, Hsin-Chu Hsien (TW); CHANG-SHOU CHEN, Hsin-Chu Hsien (TW); CHEN-CHAO LIU, Hsin-Chu Hsien (TW)

(21) Appl. No.: 17/523,318

(22) Filed: Nov. 10, 2021

(51) Int. Cl. H01M 50/446; H01M 50/403; H01M 50/46

(52) U.S. Cl. CPC H01M 50/446; H01M 50/403; H01M 50/46

(57) ABSTRACT

The present invention provides a method for preparing a porous polymeric film material under high voltage and with high safe da solid-state lithium battery using the porous polymeric film material. The method comprises steps of dissolving a polymer in which lithium ions are movable in an organic solvent, and heating and stirring the organic solvent with the polymer to obtain a solution; adding a lithium salt to the solution and then heating and stirring the solution; coating the solution on a substrate and then baking the substrate; and removing the substrate to obtain a film after the substrate is baked, and then vacuum-drying the film to obtain the porous polymeric film material. The porous polymeric film material is provided between a positive electrode material layer and a negative electrode material layer to obtain a solid-state lithium battery structure.

### FIELD OF THE INVENTION

The preset invention is related to a method for preparing porous a polymeric film material under high voltage and with good safety and a solid-state lithium battery using the porous polymeric film material, especially a preparation method that reduces the interface impedance between a solid electrolyte film and an electrode and is resistant to attenuation, and has flame retardancy and an effect of improving battery safety and can produce other excellent performances.

### BACKGROUND OF THE INVENTION

Lithium-ion batteries are now widely used in portable electronics, electric vehicles, hybrid electric vehicles, other power storage and power supply equipment due to their advantages, such as high energy density, no memory effect, wide operating temperature, fast charging/discharging rate, long cycle life, low self-discharging and lightweight. In recent years, due to the rapid development of lithium-ion battery technology, its application range has become more and more extensive. As for applications in new technical fields, new requirements for the performance of lithium-ion batteries are constantly raised, such as higher energy density (high voltage and high capacity) and better safety.

In order to improve the energy density of lithium-ion batteries, researchers mainly have developed high-capacity and high-voltage cathode materials. The actual researching results include the use of lithium cobalt oxide under higher operating voltage or lithium nickel manganese oxide under higher operating voltage. For example, the working voltage of the lithium nickel manganese oxide (LiNi_{0.5}Mn_{1.5}O₄) as a new high-voltage cathode core material can reach 5V. However, generally, the conventional electrolyte will gradually suffer decomposition reaction when its charging and discharging working voltage is greater than 4.5V. This is because the commonly used organic carbonate solvents have low oxidation potential voltage, and thus are prone to oxidative decomposition under high voltage, resulting in reducing the performance of lithium-ion batteries. The general electrolyte can no longer meet the needs of lithium-ion batteries under high-voltage, so that the further development of electrolytes used under high-voltage is very important.

Furthermore, commonly used volatile and flammable liquid electrolytes will have a great impact on the safety of lithium-ion batteries, because after multiple charging/discharging cycles, the battery is prone to produce needle-like lithium dendrite (Lithium dendrite), resulting in the internal short circuit of the battery, which would cause problems such as overheating, burning or even explosion. Although the existing development of the application of solid-state electrolyte film in all-solid-state lithium batteries (ASSLB) can effectively avoid the problems of electrolyte leakage and needle-like lithium dendrite growth, the solid electrolyte film and the electrode are prone to excessively high interface impedance due to insufficient contact, thereby reducing battery performance. There are many types of solid electrolytes currently being studied, and each type of solid electrolytes has its own advantages and disadvantages, but all above electrolytes are difficult to meet the requirement of a stable contact with metal lithium, resisting from being pierced by lithium dendrites, withstanding high voltage and matching with high voltage cathode materials. Therefore, it is a huge challenge to prepare a solid-state battery that can simultaneously meet all aspects of above requirement. Regarding lithium battery in prior art, what is required to improve is how to reduce the interface impedance between the solid electrolyte film and the electrode, how to raise the safety of the battery and enable the battery to have excellent performance.

### SUMMARY OF THE INVENTION

In view of this, the inventor of the present invention has researched continuously to solve above technical problems, so as to provide a method for preparing a porous polymeric film material under high voltage and with high safety and can be applied to solid-state lithium batteries.

The object of the present invention is to provide a method of preparing polymeric film material under high voltage and with high safety and a solid-state lithium battery using the porous polymeric film material that reduces the interface impedance between the solid electrolyte film and the electrode, resistance to attenuation; has flame retardancy, higher safety and excellent performance.

In order to fulfill above object, the present invention provides a method for preparing a porous polymeric film material under high voltage and with high safety, comprising:

a step a, dissolving a polymer in which lithium ions are movable in an organic solvent, and heating and stirring the organic solvent with the polymer to obtain a solution;

a step b, adding a lithium salt to the solution and then heating and stirring the solution;

a step c, coating the solution on a substrate and then baking the substrate; and

a step d, removing the substrate to obtain a film after the substrate is baked, and then vacuum-drying the film to obtain the porous polymeric film material.

In one embodiment, step d, the porous polymeric film material is further impregnated with electrolyte.

In one embodiment, the polymer includes Polyacrylonitrile (PAN), Polymethyl methacrylate (PMMA), Polyvinylidene fluoride-hexafluoropropylene copolymer (PVDF-HFP), Polyethylene glycol (PEG), Polyethylene oxide (PEO), Polyvinylidene difluoride (PVDF), Polypropylene carbonate (PPC), Polyvinyl alcohol (PVA) or a combination thereof.

In one embodiment, the organic solvent includes Dimethyl sulfoxide (DMSO), N-Methyl-2-pyrrolidone (NMP), Dimethylformamide (DMF), Tetrahydrofuran (THF) or a combination thereof.

In one embodiment, the lithium salt includes Lithium hexafluorophosphate (LiPF₆) and its derivatives, Lithium bistrifluoromethanesulfonimide (LiTFSI) and its derivatives, Lithium bisfluorosulfonimide (LiFSI) and its derivatives, Lithium bis(oxalate)borate (LiBOB) and its derivatives, Lithium difluoro(oxalato)borate (LiDFOB) and its derivatives, Lithium tetrafluoroborate (LiBF₄) and its derivatives, Lithium perchlorate (LiClO₄) and its derivatives, and a mixture thereof.

In one embodiment, the substrate is a metal film, a high temperature resistant release film or a transparent conductive oxide including Indium tin oxide (ITO), Polyethylene terephthalate (PET), or Polystyrene sulfonate (PSS).

In one embodiment, in the step a, the heating and stirring is performed under a temperature between 25° C. and 100° C.; in the step b, the heating and stirring is performed under a temperature between 25° C. and 50° C.; in the step c, the baking is performed under a temperature between 25° C. and 110° C.; in the step d, the vacuum-drying is performed under a temperature between 25° C. and 110° C.

The present invention further provides a solid-state lithium battery, comprising:

a positive electrode material layer;

a negative electrode material layer, stacked and placed above the positive electrode material layer; and

a porous polymeric film material prepared by the method as claimed in claim 1, sandwiched between the positive electrode material layer and the negative electrode material layer, where electrolyte solution is provided between the porous polymeric film material and the positive electrode material layer and between the porous polymeric film material and the negative electrode material layer.

In one embodiment, the porous polymeric film material is further impregnated with electrolyte.

The present invention will be understood more fully by reference to the detailed description of the drawings and the preferred embodiments below.

### BRIEF DESCRIPTION OF DRAWINGS

FIG. 1 is a flow chart showing the method for preparing a porous polymeric film material under high voltage and with high safety of the present invention.

FIG. 2 is a diagram showing the electrochemical stability window of LSV after the porous polymeric film material prepared by adding different lithium salts in Example 1 and then impregnating the porous polymeric film material with a liquid electrolyte.

FIG. 3 is a burning test diagram with a gas flame gun showing the porous polymeric film materials prepared by adding different lithium salts in Example 1.

FIG. 4 is a burning test diagram with a gas flame gun showing the porous polymeric film material prepared by adding different lithium salts in Example 1 and then impregnated with liquid electrolyte.

FIG. 5 is an SEM diagram of the porous polymeric film material prepared by adding different lithium salts in Example 1.

FIG. 6 is an optical microscope diagram of the porous polymeric film material prepared by adding different lithium salts in Example 1 at different drying temperatures.

FIG. 7 is a cross-sectional view of the sample prepared in Example 1 applied to a solid-state lithium battery.

FIGS. 8A-8H illustrate a charging-discharging curve obtained by impregnating the sample prepared in Example 1 with the liquid electrolyte and then assembling the solid-state lithium battery (LiNi_{0.5}Mn_{1.5}O₄|sample 1˜4@ liquid electrolyte|Li) at the same charge-discharge rate (0.5C) and a coulombic efficiency diagram under the cycle charge-discharge of the solid-state lithium battery.

FIG. 9 is a diagram showing the capacity distribution curve at different charging-discharging rates (0.1C˜5.0C) at room temperature of a solid-state lithium battery assembled after the sample prepared in Example 1 is impregnated with liquid electrolyte.

FIG. 10 is a diagram showing the capacity distribution curve at different temperatures and at the same charge-discharge rate (0.5C) of a solid-state lithium battery assembled after impregnating the sample prepared in Example 1 with liquid electrolyte.

### DETAILED DESCRIPTIONS OF PREFERRED EMBODIMENTS

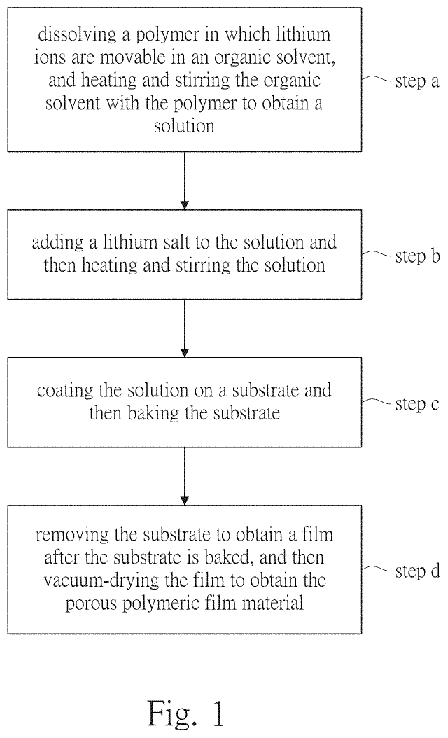

Please refer to FIG. 1, the present invention provides a method for preparing a porous polymeric film material under high voltage and with high safety, comprising:

a step a, dissolving a polymer in which lithium ions are movable in an organic solvent, and heating and stirring the organic solvent with the polymer to obtain a solution;

a step b, adding a lithium salt to the solution and then heating and stirring the solution;

a step c, coating the solution on a substrate and then baking the substrate; and

a step d, removing the substrate to obtain a film after the substrate is baked, and then vacuum-drying the film to obtain the porous polymeric film material.

In one embodiment, the polymer and the organic solvent are first mixed in a weight ratio of 1:4 (calculated based on the total weight of the organic solvent with the polymer to be prepared), and then the organic solvent are heated and stirred with the polymer at 25° C. to 100° C. for 1 to 12 hours to obtain the above solution. The polymer includes Polyacrylonitrile (PAN), Polymethyl methacrylate (PMMA), Polyvinylidene fluoride-hexafluoropropylene copolymer (PVDF-HFP), Polyethylene glycol (PEG), Polyethylene oxide (PEO), Polyvinylidene difluoride (PVDF), Polypropylene carbonate (PPC), Polyvinyl alcohol (PVA) or a combination thereof. The organic solvent includes Dimethyl sulfoxide (DMSO), N-Methyl-2-pyrrolidone (NMP), Dimethylformamide (DMF), Tetrahydrofuran (THF) or a combination thereof.

Then, the lithium salt is added to the solution at a weight ratio of 0.8 compared to the total weight of the solution to be prepared, and then the solution is heated and stirred at 25° C. to 50° C. for 1 to 6 hours. The lithium salt includes Lithium hexafluorophosphate (LiPF₆) and its derivatives, Lithium bistrifluoromethanesulfonimide (LiTFSI) and its derivatives, Lithium bisfluorosulfonimide (LiFSI) and its derivatives, Lithium bis(oxalate)borate (LiBOB) and its derivatives, Lithium difluoro(oxalato)borate (LiDFOB) and its derivatives, Lithium tetrafluoroborate (LiBF₄) and its derivatives, Lithium perchlorate (LiClO₄) and its derivatives, and a mixture thereof.

Then, the solution is coated on a substrate (i.e. the step c) with a coating blade having a thickness from 20 to 100 um, and the substrate is baked at 25° C. to 110° C. for 1 to 12 hours. The substrate is a metal film (such as gold, silver, platinum, copper, aluminum and other metals), a high-temperature resistant release film or a transparent conductive oxide including Indium tin oxide (ITO), Polyethylene terephthalate (PET), or Polystyrene sulfonate (PSS) and so on.

Subsequently, as described in the step d, when the substrate is removed after being baked, a film body can be obtained. The porous polymeric film material can be obtained after the film body is vacuum-dried at 25° C. to 110° C. for 1 to 6 hours.

Therefore, users can cut the completely-dried porous polymeric film material into a circular film with a diameter of 19 mm, and store it in an argon atmosphere for later use.

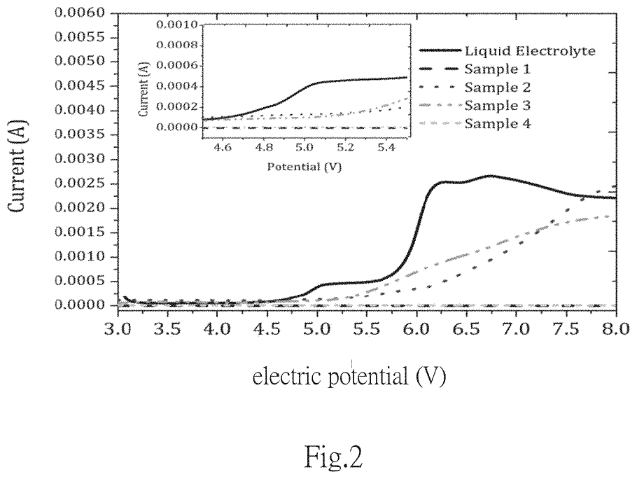

The porous polymeric film material prepared in the above embodiment is impregnated with a generally commercially available liquid electrolyte, and linear sweep voltammetry is used; wherein the sweep rate is 0.05 mV/s and the sweep potential range is 3˜8V vs. Li/Li⁺ for analysis, and the result is shown in FIG. 2. It can be clearly shown in FIG. 2 that the electrolyte impregnated with the porous polymeric film material prepared in this embodiment has a wider electrochemical window and higher withstand voltage than the conventional liquid electrolyte that is not impregnated with the porous polymeric film material of the present invention, and the porous polymeric film material of the present invention has better interface chemical stability for lithium metal.

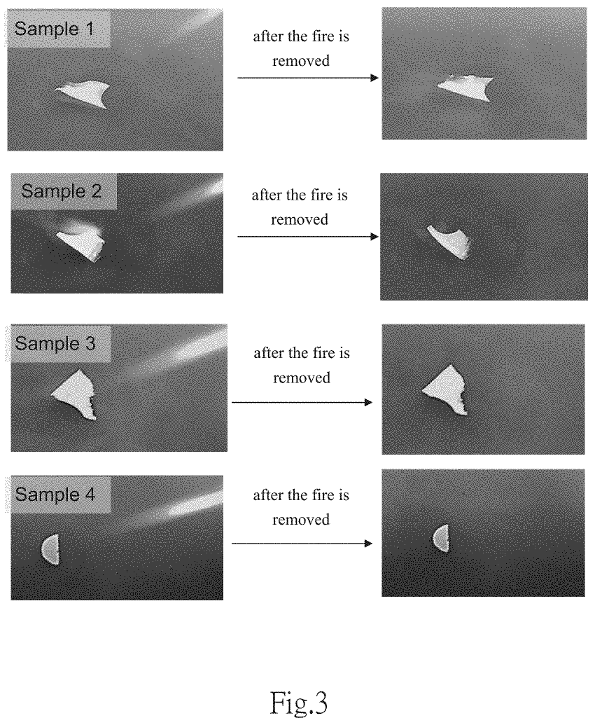

Apply a gas flame gun to test the porous polymeric film material Sample 1˜4 prepared above by direct flame contact. After the flame is in contact with the polymeric film materials for 2 to 5 seconds, the gas flame gun is removed to observe the burning situation of polymeric film materials. It can be observed that almost all of the polymeric film materials of Sample 1˜4 only have local scorch at their flame contact points. When the gas flame gun is removed, there is no burning phenomenon. Therefore, it can be proved that this polymeric film material is flame-resistant and has high safety. The test result is shown in FIG. 3.

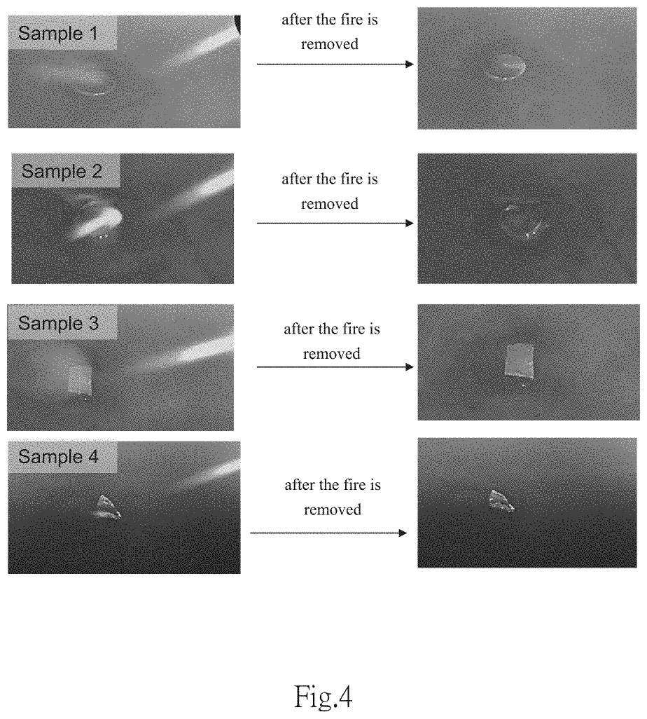

After the porous polymeric film materials of Sample 1˜4 prepared above are impregnated with commercially available liquid electrolyte, a gas flame gun is used to perform a flame burning test on the polymeric film materials in a direct contact way. After the flame is in contact with the polymeric film materials for 2 to 5 seconds, the flame gun is removed to observe the burning situation of the polymeric film materials. The test result is shown in FIG. 4, it can be observed that when the flame gun is removed from the polymeric film material of Sample 1˜4 impregnated with the electrolyte, there is no burning phenomenon. It can be proved that it is a polymeric film material with flame-resistant and high safety even after the polymeric film material impregnated with liquid electrolyte.

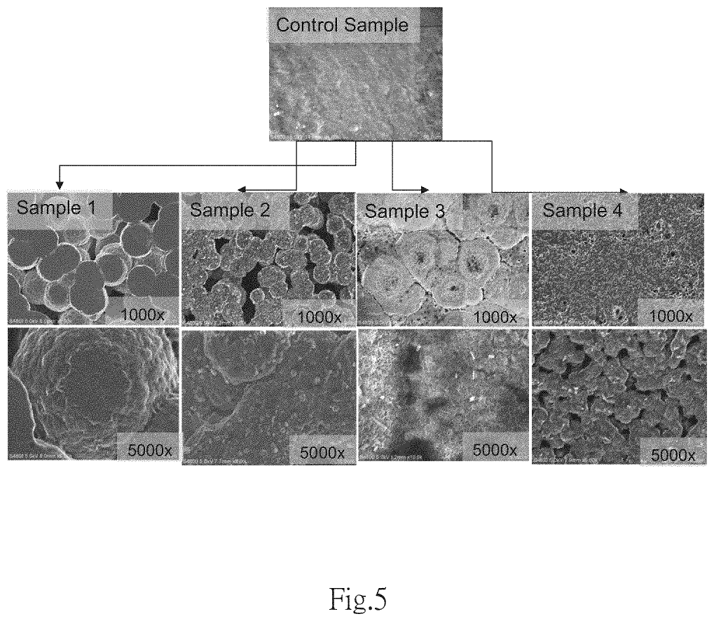

FIG. 5 is an SEM diagram of Sample 1 to 4 of porous polymeric film materials prepared by adding different lithium salts in the above embodiment. It can be understood from the SEM diagram that the porous polymeric film materials prepared under the same procedure and composition ratio but with different lithium salts have different surface morphologies shown by the SEM diagram. When the lithium salt is not added, the surface morphology of the polymeric film material is flat and has no porosity. After the lithium salt is added, it can be observed that the surface morphology of the polymeric film material is changed greatly.

As for Sample 1, it appears to be a porous polymeric film material stacked by large and dense spheroids. As for Sample 2, its spheroids are smaller than those of Sample 1, but the spheroids are denser, and there are some holes on its surface, and the denser spheroids are stacked to from a porous polymeric film material. As for Sample 3, the surface morphology of the formed polymeric film material looks like stacked breads, and they are still connected to each other. In detail, its structure is not as dense as Sample 1 and Sample 2, but a lot of micro-porous structures are formed in the polymer film material to form the porous polymeric film material of the present invention. As for Sample 4, the surface morphology of the formed polymeric film material looks like a porous film structure, which is different from the surface morphology of other samples.

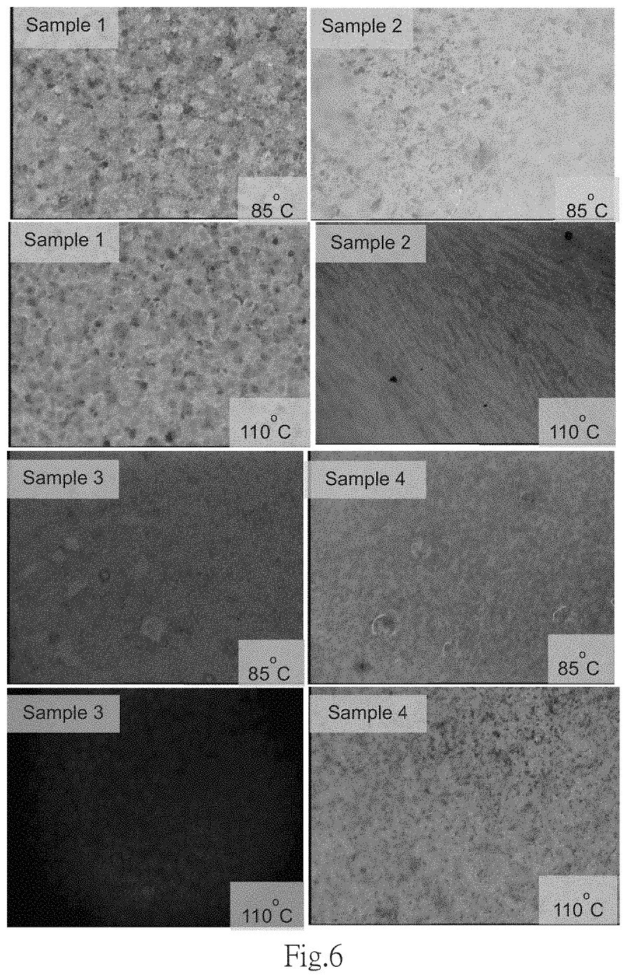

Based on this, we also tested the amount of impregnation (%) of the liquid electrolyte and the prepared porous polymeric film material, which can be shown in Table 1 below. The data obtained in Table 1 is the result of drying the porous polymeric film materials of the present invention at different temperatures. When the baking temperature is relatively high, the impregnation content of the liquid electrolyte is relatively more. We also use an optical microscope to observe the surface morphology. It can be observed that all the prepared Samples 1, 3 and 4 have bigger pores when the baking temperature is higher, while Sample 2 has a special micro-structure and relatively small pores, such that its increase in electrolyte impregnation is relatively small. The test results are shown in FIG. 6.

TABLE 1

| The amount of | | |
|---|---|---|
| liquid electrolyte | The baking | The baking |
| impregnation (%) | temperature(85° C.) | temperature(100° C.) |
| Sample1 | 95.16% | 146% |
| Sample2 | 143.3% | 164.7% |
| Sample3 | 168.2% | 229.5% |
| Sample4 | 130.5% | 232% |

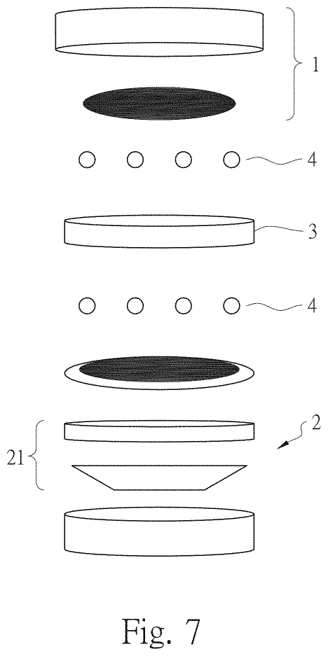

The detailed structure of the battery composition of the relevant charging and discharging experiments of the solid-state lithium battery of the present invention can be referred to FIG. 7. The CR2032 coin cell battery is used as the carrier for the experimental material. A solid-state lithium battery, comprising: a positive electrode material layer 1, a negative electrode material layer 2 and the above mentioned porous polymer film material 3. The negative electrode material layer is stacked and placed above the positive electrode material layer. The porous polymeric film material 3 is impregnated with electrolyte, and is sandwiched between the positive electrode material layer 1 and the negative electrode material layer 2, and electrolyte solution 4 is provided between the porous polymeric film material 3 and the positive electrode material layer 1 and between the porous polymeric film material 3 and the negative electrode material layer 1. A buffer metal ring and gasket for battery packaging are embedded inside the negative electrode material layer 2, and a tight plastic gasket 21 is included in the negative electrode material layer 2 to prevent the material contained in the lithium battery from flowing out.

In one embodiment, The positive electrode material layer 1 can be a lithium-rich manganese-based layered structure, and its chemical formula is xLi₂MnO₃.(1−x)LiMO₂, where M is one or more materials doped with transition metal, such as manganese (Mn), nickel (Ni), cobalt (Co), aluminum (Al), magnesium (Mg) and so on, or M is spinel lithium nickel manganate (chemical formula: LiNi_{0.5}Mn_{1.5}O₄) and related derivatives doped with transition metal thereof. The negative electrode material layer 2 can be lithium metal or surface-treated lithium metal, or carbon-based materials such as carbon, graphite, mesocarbon microbeads (MCMB), and non-carbon-based metal oxides. The porous polymeric film material is the embodiment shown in the specification of the present invention, and their impregnated electrolyte can be 1.0M LiPF₆, EC/DMC=1/2 Vol % or self-developing electrolyte or other commercially available electrolyte.

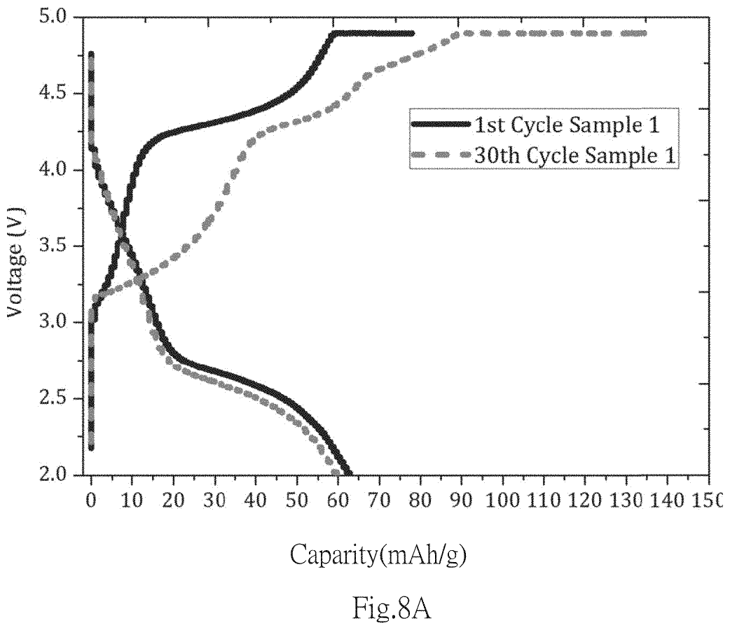

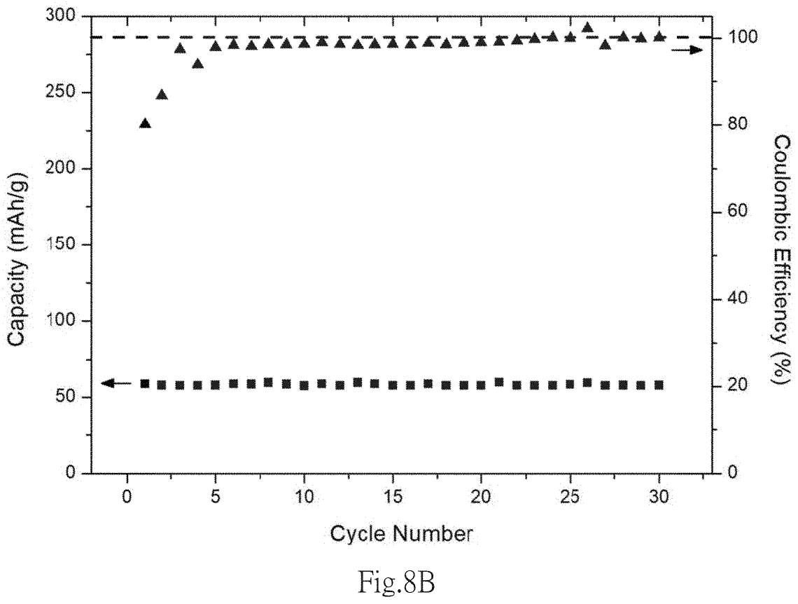

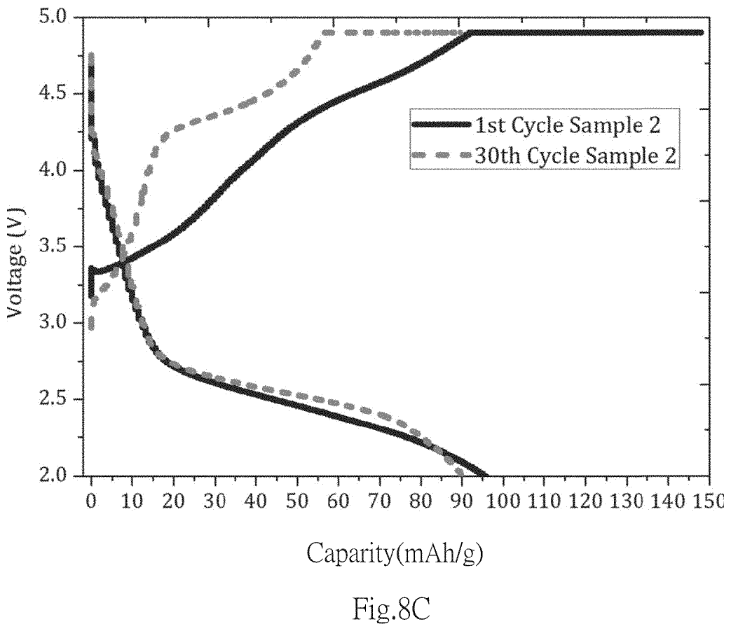

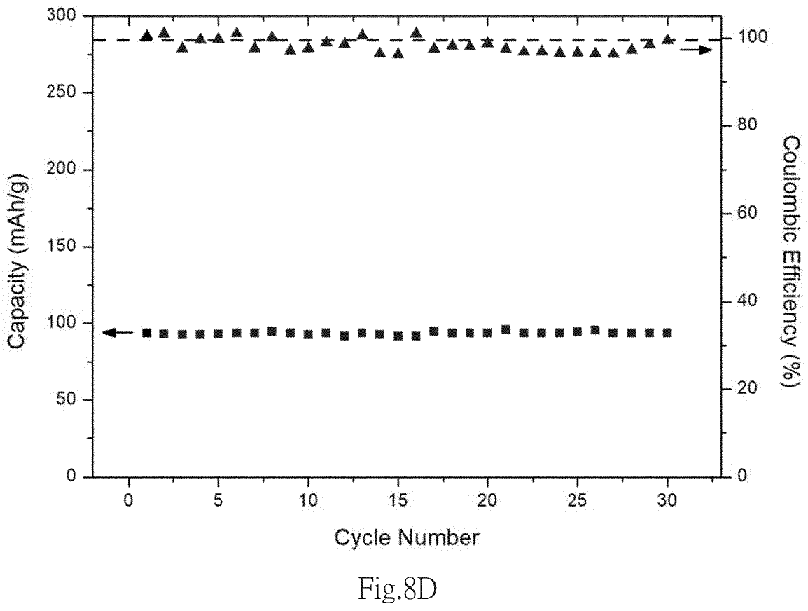

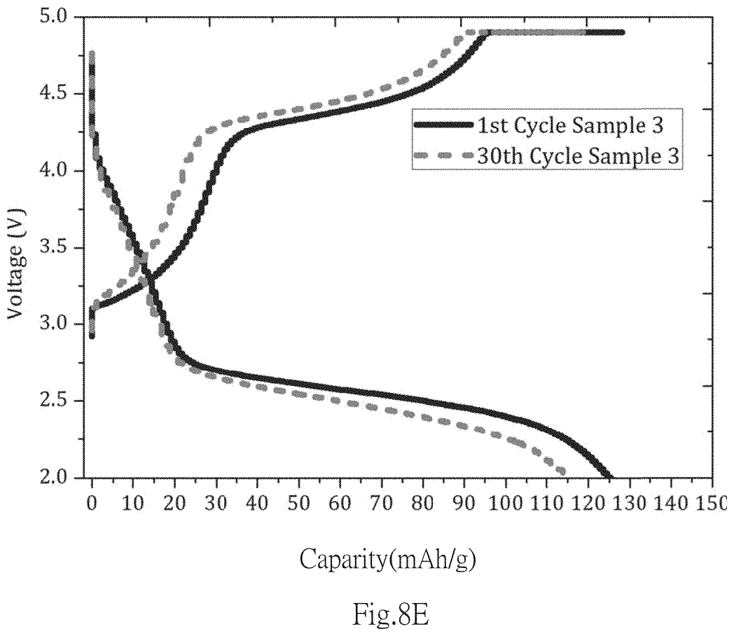

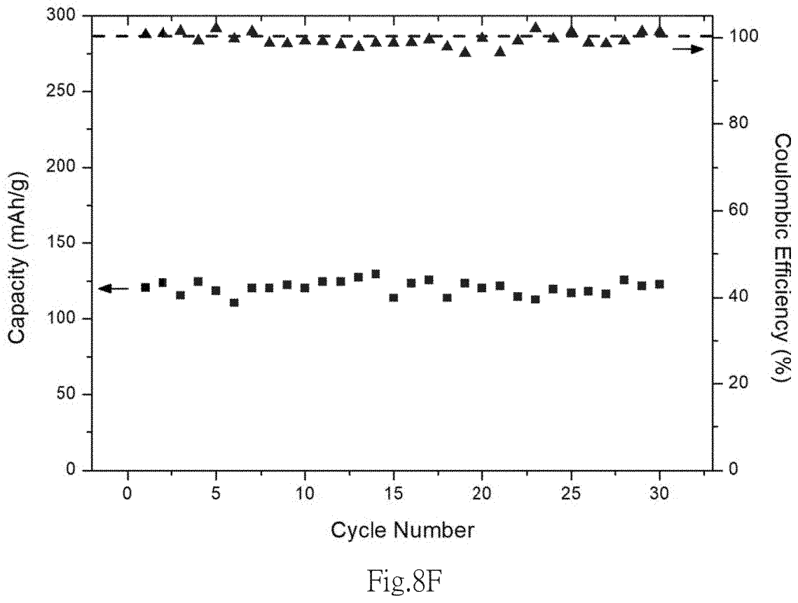

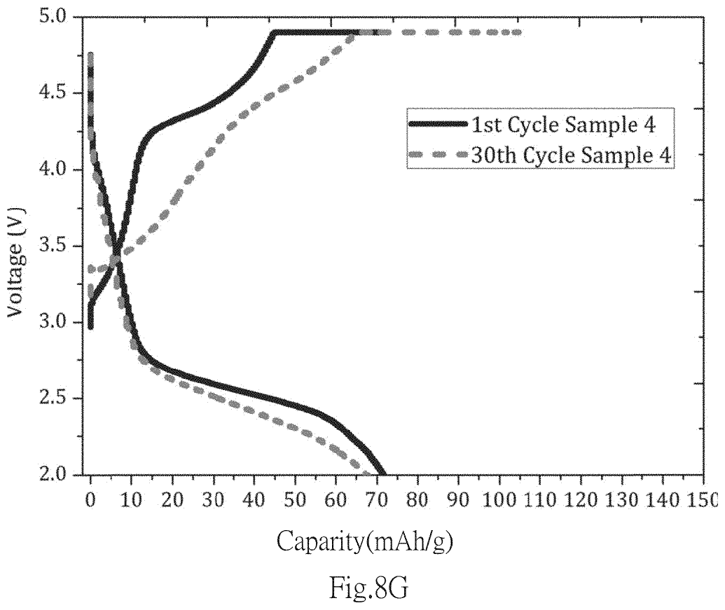

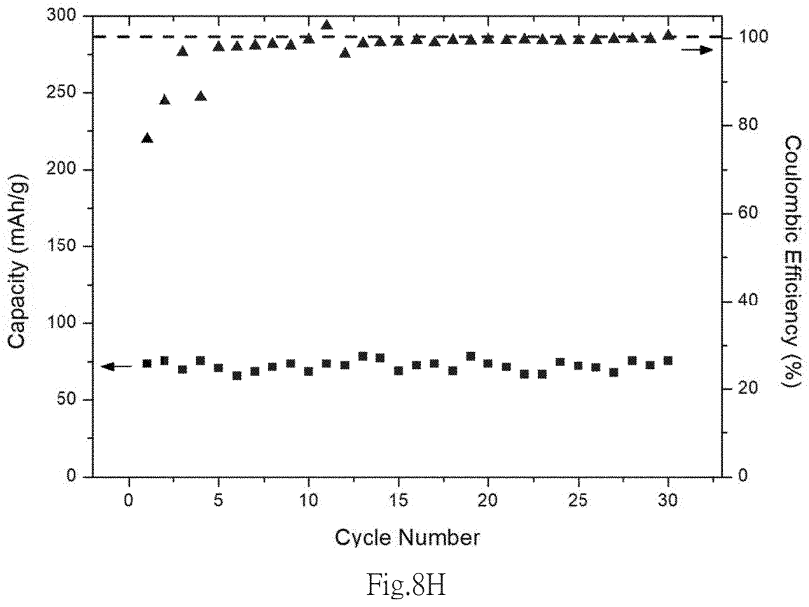

The solid-state lithium battery assembled after the porous polymeric film material prepared with the different lithium salts of Example 1 is impregnated with the liquid electrolyte at room temperature and then is subjected to charging-discharging tests. The results are shown in FIGS. 8-10, respectively. FIGS. 8A-8H show the capacity curve obtained at the same charging-discharging rate of 0.5C. The discharging capacity of the first laps of Samples 1-4 are 63.4 mAh/g, 94.5 mAh/g, 125.4 mAh/g, 71.5 mAh/g, respectively. The discharging capacity of samples 1˜4 after 30 cycles of charging-discharging tests at room temperature are 59.7 mAh/g, 90.1 mAh/g, 117.3 mAh/g, 67.8 mAh/g, respectively. Comparing the overall charging-discharging coulombic efficiency shows that after the porous polymer film material prepared by the method of the present invention is impregnated with liquid electrolyte, no matter which lithium salt is used, the overall charging-discharging coulombic efficiency is almost near 100%, which means that after these porous polymeric film materials are impregnated with liquid electrolyte, with the number of cycles of charging increases, the overall coulombic efficiency curve is relatively stable and there is almost no attenuation.

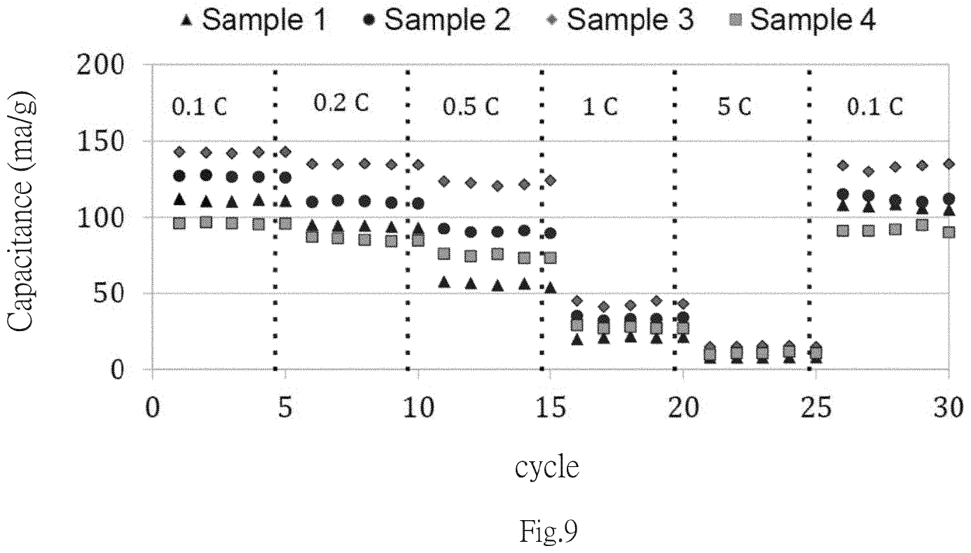

The polymeric film material prepared by the present invention is assembled to form a lithium battery with different charging-discharging rate capabilities. Please refer to FIG. 9, under different conditions of 0.1C, 0.2C, 0.5C, 1.0C, 5.0C (charging/discharging), the battery of the present invention is subjected to a charging-discharging life test for 5 cycles. As for samples 1, 2, 3 and 4, it can be found that the cycle capacitance stability has better electrical performance. When the charging-discharging current returns from 5C to 0.1C, no matter it is the sample 1, 2, 3 or 4, its overall capacitance has almost returned to the state of 0.1C, and it also has a stable cycle capacitance performance.

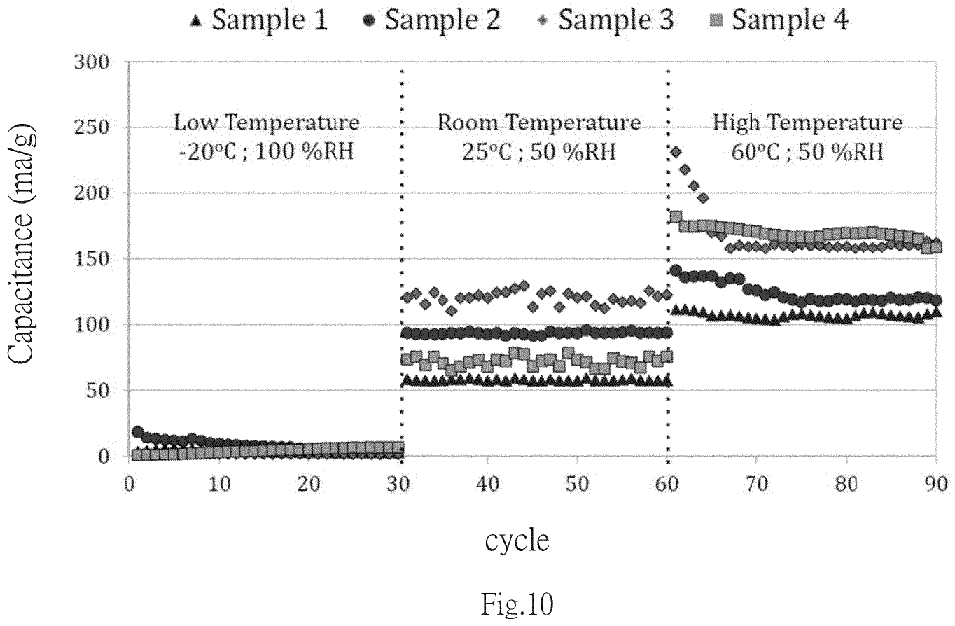

Please refer to FIG. 10, charging-discharging samples of porous polymer film materials prepared from different lithium salts prepared in Example 1 at 0.5C/0.5C after the samples are impregnated with liquid electrolyte respectively, matched with LiNi_{0.5}Mn_{1.5}O₄ positive electrode material of lithium battery, and then the samples are subjected to a charging-discharging cycle test. The results show that after the porous polymeric film material prepared by the method of the present invention is impregnated with liquid electrolyte, the temperature of the battery continuously returns to room temperature (25° C.) from low temperature (−20° C.), and finally rises to high temperature (60° C.), all with stability cycle of charging-discharging. Due to the temperature effect, the overall capacitance performance is poor at low temperatures but stable charging-discharging are still performed. When the temperature returns to room temperature, the overall capacitance slowly increases, and can perform stably charging-discharging. Finally, when the temperature rises to such a high temperature of 60° C., the capacitance at the beginning is slightly higher, and then the charging-discharging can be carried out stably after the capacitance slightly decreases. In summary, the porous polymeric film material under high voltage and with high safety of the present invention has better flame resistance, a wide electrochemical window, and the solid-state lithium battery including the same of the present invention can be used under high room temperature and has high temperature charging/discharging capacity per gram, high coulombic efficiency, and better charging-discharging cycle stability, so they can indeed achieve the object of the present invention.

The description referred to in the drawings and stated above is only for the preferred embodiments of the present invention. Many equivalent variations and modifications can still be made by those skilled at the field related with the present invention and do not depart from the spirit of the present invention, so they should be regarded to fall into the scope defined by the appended claims.

To sum up, the method for preparing a porous polymeric film material under high voltage and with high safety and the solid-state lithium battery using the porous polymeric film material provided by the present invention can indeed meet its anticipated object, and it is new and can be put into industrial use.

What is claimed is:

1. A method for preparing a porous polymeric film material under high voltage and with high safety, comprising:
a step a, dissolving a polymer in which lithium ions are movable in an organic solvent, and heating and stirring the organic solvent with the polymer to obtain a solution;
a step b, adding a lithium salt to the solution and then heating and stirring the solution;
a step c, coating the solution on a substrate and then baking the substrate; and
a step d, removing the substrate to obtain a film after the substrate is baked, and then vacuum-drying the film to obtain the porous polymeric film material.

2. The method as claimed in claim 1, wherein in step d, the porous polymeric film material is further impregnated with electrolyte.

3. The method as claimed in claim 1, wherein the polymer includes Polyacrylonitrile (PAN), Polymethyl methacrylate (PMMA), Polyvinylidene fluoride-hexafluoropropylene copolymer (PVDF-HFP), Polyethylene glycol (PEG), Polyethylene oxide (PEO), Polyvinylidene difluoride (PVDF), Polypropylene carbonate (PPC), Polyvinyl alcohol (PVA) or a combination thereof.

4. The method as claimed in claim 1, wherein the organic solvent includes Dimethyl sulfoxide (DMSO), N-Methyl-2-pyrrolidone (NMP), Dimethylformamide (DMF), Tetrahydrofuran (THF) or a combination thereof.

5. The method as claimed in claim 1, wherein the lithium salt includes Lithium hexafluorophosphate (LiPF₆) and its derivatives, Lithium bistrifluoromethanesulfonimide (LiTFSI) and its derivatives, Lithium bisfluorosulfonimide (LiFSI) and its derivatives, Lithium bis (oxalate)borate (LiBOB) and its derivatives, Lithium difluoro (oxalato)borate (LiDFOB) and its derivatives, Lithium tetrafluoroborate (LiBF₄) and its derivatives, Lithium perchlorate (LiClO₄) and its derivatives, and a mixture thereof.

6. The method as claimed in claim 1, wherein the substrate is a metal film, a high temperature resistant release film or a transparent conductive oxide including indium tin oxide (ITO), Polyethylene terephthalate (PET), or Polystyrene sulfonate (PSS).

7. The method as claimed in claim 1, wherein in the step a, the heating and stirring is performed under a temperature between 25° C. and 100° C.; in the step b, the heating and stirring is performed under a temperature between 25° C. and 50° C.; in the step c, the baking is performed under a temperature between 25° C. and 110° C.; in the step d, the vacuum-drying is performed under a temperature between 25° C.

8. A solid-state lithium battery, comprising:
a positive electrode material layer;
a negative electrode material layer, stacked and placed above the positive electrode material layer; and
a porous polymeric film material prepared by the method as claimed in claim 1, sandwiched between the positive electrode material layer and the negative electrode material layer, where electrolyte solution is provided between the porous polymeric film material and the positive electrode material layer and between the porous polymeric film material and the negative electrode material layer.

9. The solid-state lithium battery as claimed in claim 8, wherein the porous polymeric film material is further impregnated with electrolyte.
